(19) United States
(12) Patent Application Publication
(10) Pub. No.: US 2006/0078665 A1
(43) Pub. Date: Apr. 13, 2006

(54) Roll-style dough product having a fried-like texture

(76) Inventors: Sherri A. Slocum, Plymouth, MN (US); Kristina M. Hedges, Golden Valley, MN (US); Stephen M. Jacobsen, Champlin, MN (US); Annavarapu S. Murty, Spring Valley, WI (US)

Correspondence Address: General Mills, Inc., Number One General Mills Boulevard, Minneapolis, MN, 55426, US

(21) Appl. No.: 10/960,770

(22) Filed: Oct. 7, 2004

(51) Int. Cl. A21D 10/00

(52) U.S. Cl. 426/549

(57) ABSTRACT

A roll-style dough product presenting the taste and textural experience of traditional Texas Toast but in a convenient and appealing roll-type format. The roll-style dough product provides a consumer food product having a crust with a crisp, “fried-like” texture and a flavor component. The roll-style dough product can be provided in a variety of preparatory states including a fully baked product or a partially baked or par-baked product. The roll-style dough product can be provided as a raw dough product, a frozen dough product or a refrigerated dough product. The roll-style dough product can be presented in a sectioned or pull-apart configuration. The invention further relates to a process for preparing a roll-style dough product having the textural and taste characteristics associated with Texas Toast. The invention further relates to a refrigerator-to-oven baking kit for preparing roll-style dough products having the textural and taste characteristics of Texas Toast.

### FIELD OF THE INVENTION

This invention relates generally to a roll-style dough product. In particular, the invention relates to a roll that when baked, develops a crisp, “fried-like” exterior texture.

### BACKGROUND OF THE INVENTION

A variety of specialized breads provide unique tasting products having pre-applied or pre-added flavor that goes beyond the usual bread-with-butter. For example, some popular bread products include Texas Toast, Italian-style bread, garlic bread, tomato focaccia, cheese-filled or cheese-topped bread and the like. Conventionally, this has been achieved by applying flavorings, herbs, spices, a fat composition or other additives, on the surface of baked and sliced bread or by incorporating the additives into the bread dough prior to baking.

As mentioned above, Texas Toast is one popular example of a flavored specialized bread product. Traditionally, Texas Toast has generally comprised a thickly sliced piece of bread having large amounts of butter and other flavorings spread on both sides that is subsequently baked until the crust has a quality of crispness. When consumed, the large amount of fat provides a consumer with an intense flavor sensation along with a desirable, crispy texture.

Texas Toast can be made from a variety of recipes and is also available in a frozen bread loaf format for cooking in a toaster. While traditional, sliced Texas Toast offers consumers a satisfying taste experience, it would be advantageous to have a Texas Toast-type product that delivers similar taste and textural experiences in an alternative format that is more versatile and requires less processing steps than sliced Texas Toast.

### SUMMARY OF THE INVENTION

The embodiments of the invention described below are not intended to be exhaustive or to limit the invention to the precise forms disclosed in the following detailed description. Rather, the embodiments are chosen and described so that others skilled in the art may appreciate and understand the principles and practices of the invention.

The invention relates to a dough product presenting the taste and textural qualities of traditional Texas Toast but available in a convenient and appealing roll-type format. The dough product as provided herein yields a consumer food product having a crisp, “fried-like” bottom crust with a flavor component disposed thereon, and an aesthetically desirable shape.

In one embodiment, the invention is a roll-style dough product having a crisp, “fried-like” bottom crust delivering similar taste and textural characteristics as traditional Texas Toast. The roll-style dough product can further include a top surface having a crisp, “fried-like” surface. The top and bottom surfaces can, either separately or in combination, include flavorings such that a consumer simultaneously experiences intense flavor along with the textural sensations. The roll-style dough product can be provided in a variety of preparatory states including a fully baked product or a partially baked or par-baked product. The roll-style dough product can also be provided in a raw, refrigerated or frozen form. The roll-style dough product can be presented in a portioned or pull-apart configuration allowing a consumer to conveniently separate the dough product such that the portions can be individually consumed or dipped into other foods such as soup, sauce or gravy to absorb additional flavors.

In another embodiment, the invention relates to a process for preparing a roll-style dough product having the textural and taste characteristics associated with Texas Toast.

In yet another embodiment, the invention relates to a baking kit for preparing roll-style dough products having the textural and taste characteristics of Texas Toast. The refrigerator-to-oven baking kit can include an oven-ready pan containing a plurality of dough intermediates.

### BRIEF DESCRIPTION OF THE DRAWINGS

These, as well as other objects and advantages of this invention, will be more completely understood and appreciated by referring to the following more detailed description of the exemplary embodiments of the invention in conjunction with the accompanying drawings, of which:

FIG. 1 is a perspective view of a baked roll according to an embodiment of the invention;

FIG. 2 is a top view of the baked roll of FIG. 1;

FIG. 3 is a bottom view of the baked roll of FIG. 1;

FIG. 4 is an exemplary process flow diagram for making the baked roll of FIG. 1;

FIG. 5 is a top view of a baking pan with an edible cooking fat in a walled recess;

FIG. 6 is a top cut-away view of the baking pan of FIG. 5 with a portioned amount of dough in each walled recess;

FIG. 7 is a top perspective, cut-away view of the baking pan of FIG. 6 with a stamped dough intermediate in each walled recess;

FIG. 8 is a top cut-away view of the baking pan of FIG. 7 with a second edible cooking fat on a top surface of each stamped dough intermediate;

FIG. 9 is a top cut-away view of the baking pan of FIG. 8 with a plurality of proofed dough intermediates; and

FIG. 10 is a top cut-away view of the baking pan of FIG. 9 with a plurality of par-baked dough intermediates.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The invention is now illustrated in greater detail by way of the following detailed description, but it should be understood that the invention is not to be construed as being limited thereto.

As used herein, the term “dough intermediate” refers to dough-based products, such as rolls, biscuits, buns, and the like that require a further thermal processing step by the end user prior to consumption.

As used herein, the term “fried-like” refers to a cooked surface providing a crisp, grease releasing surface providing for near instantaneous release of flavor upon consumption.

As used herein, the term “immediate flavor impact” refers to a fast flavor impact upon biting into a food product. Immediate flavor impact generally occurs prior to any chewing in the mouth.

As used herein, the term flavorant encompasses dried and/or dehydrated ingredients, powdered ingredients, particulate ingredients, toppings, fresh ingredients, and flavors in a variety of forms including solid and liquid flavors.

It has been found that by applying a liquid fat or oil to the surfaces of a raw dough prior to a finishing step such as baking or heating, a baked dough product can be obtained having a crisp, “fried-like” texture.

The attainment of certain dough characteristics are more important in some doughs than in others, and depend largely on the intended end use of the dough product. In particular embodiments, a method of the invention will be more advantageously used in certain varieties of doughs. For example, dough extensibility may be more important in developed doughs than in undeveloped doughs. Developed doughs are those in which a protein network has been more or less fully formed or created. Examples of developed doughs include dough for breads or rolls. Undeveloped doughs are those in which a protein network is not yet fully formed. One example of an undeveloped dough is biscuit dough.

Dough formulations, and the ingredients they contain, can differ depending on the finished product that is obtained from the dough. However, most doughs do generally have a number of ingredients in common and examples of some such common ingredients are described and illustrated in more detail below.

The dough of the invention generally contains a grain constituent that contributes to the structure of the dough. Different grain constituents lend different texture, taste and appearance to a baked good. Flour is the most commonly used grain constituent in baked goods, and in most baked foods is the primary ingredient.

Suitable flours include hard wheat flour, soft wheat flour, corn flour, high amylose flour, low amylose flour, and the like. For example, a dough product made with a hard wheat flour will have a more coarse texture than a dough made with a soft wheat flour due to the presence of a higher amount of gluten in hard wheat flour.

Bread flours are primarily milled from hard red winter or spring wheat. Generally these flours have a protein content of about 11.0-12.5%. Certain baked products may require stronger bread flours with about 1-2% higher protein content.

In bread making, flour may comprise up to about 95 weight percent of the dry ingredients. In bread, when the flour comes in contact with water, and the ingredients are mixed, the gluten protein fraction forms elastic, gas-retaining films.

A dough composition of the invention can be caused to expand (leaven) by any leavening mechanism, such as by one or more of the effects of: entrapped gas such as entrapped carbon dioxide, entrapped oxygen, or both; a laminated dough structure; by action of chemical leavening agents; or by action of a biological agent such as a yeast. Thus, a leavening agent may be an entrapped gas such as layers or cells (bubbles) that contain carbon dioxide, water vapor, or oxygen, etc.; any type of yeast (e.g., cake yeast, cream yeast, dry yeast, etc.); or a chemical leavening system, e.g., containing a basic chemical leavening agent and an acidic chemical leavening agent that react to form a leavening gas such as carbon dioxide.

Examples of acidic chemical leavening agents are generally known in the dough and bread-making arts, with examples including sodium aluminum phosphate (SALP), sodium acid pyrophosphate (SAPP), monosodium phosphate, monocalcium phosphate monohydrate (MCP), anhydrous monocalcium phosphate (AMCP), dicalcium phosphate dihydrate (DCPD), glucono-delta-lactone (GDL), as well as a variety of others. Optionally, an acidic chemical leavening agent for use according to the invention, can be encapsulated.

Examples of basic chemical leavening agents include many that are generally known in the dough and baking arts, such as soda, i.e., sodium bicarbonate (NaHCO₃), potassium bicarbonate (KHCO₃), ammonium bicarbonate (NH₄HCO₃), etc. A basic chemical leavening agent may also be encapsulated, if desired.

The evolution of carbon dioxide essentially follows the stoichiometry of typical acid-base reactions. The amount of leavening base present determines the amount of carbon dioxide evolved, whereas the type of leavening acid affects the speed at which the carbon dioxide is liberated. The amount of leavening base used in combination with the leavening acid can be balanced such that a minimum of unchanged reactants remain in the finished product. An excess amount of leavening base can impart a bitter flavor to the final product, while excess leavening acid can make the baked product tart.

Yeast is also utilized for leavening baked goods, and is often preferred because of the desirable flavor it imparts to the dough. Bakers' yeast is generally supplied in three forms: yeast cream, a thick suspension with about 17% solids; a moist press cake with about 30% solids; and an active dry yeast, with about 93 to 98% solids. Generally, active dry yeasts of acceptable quality have been available for some time, and recently instant active dry yeast has also been available for commercial use.

The quantity of yeast added to dough is directly related to the time required for fermentation, and the form of the yeast utilized. Generally, most bread doughs are made with from about 2 to 3% fresh compressed yeast, based on the amount of flour.

The dough of the invention can also contain additional ingredients. Some such additional ingredients can be used to modify the texture of dough. Texture modifying agents can improve many properties of the dough, such as viscoelastic properties, plasticity, or dough development. Examples of texture modifying agents include fats, emulsifiers, hydrocolloids, and the like.

Shortening helps to improve the volume, grain and texture of the final product. Shortening also has a tenderizing effect and improves overall palatability and flavor of a baked good. Either natural shortenings, animal or vegetable, or synthetic shortenings can be used. Generally, shortening is comprised of triglycerides, fats and fatty oils made predominantly of triesters of glycerol with fatty acids. Fats and fatty oils useful in producing shortening include cotton seed oil, ground nut oil, soybean oil, sunflower oil, rapeseed oil, sesame oil, olive oil, corn oil, safflower oil, palm oil, palm kernel oil, coconut oil, or combinations thereof.

Emulsifiers include nonionic, anionic, and/or cationic surfactants that can be used to influence the texture and homogeneity of a dough mixture, increase dough stability, improve eating quality, and prolong palatability. Emulsifiers include compounds such as lecithin, mono- and diglycerides of fatty acids, propylene glycol mono- and diesters of fatty acids, glyceryl-lacto esters of fatty acids, and ethoxylated mono- and diglycerides.

Hydrocolloids are added to dough formulations to increase moisture content, and to improve viscoelastic properties of the dough and the crumb texture of the final product. Hydrocolloids function both by stabilizing small air cells within the batter and by binding to moisture within the dough. Hydrocolloids include compounds such as xanthan gum, guar gum, and locust bean gum.

Dough-developing agents can also be added to the system to increase dough viscosity, texture and plasticity. Any number of agents known to those of skill in the art may be used including azodicarbonamide, diacetyl tartaric acid ester of mono- and diglycerides (D.A.T.E.M.) and potassium sorbate.

Another example of a dough-developing additive is PROTASE™. PROTASE™ is a proprietary product containing enzymes and other dough conditioners. PROTASE™ is generally used to reduce mixing time and improve machinability. PROTASE 2X™, a double strength version, which can be commercially obtained from J. R. Short Milling Co. (Chicago, Ill.).

Dough conditioners are also examples of dough additives. One example of a dough conditioner is NUBAKE™, commercially available from RIBUS (St. Louis, Mo.). Another example of a dough conditioner is L-cysteine, commercially available from B.F. Goodrich (Cincinnati, Ohio).

Dough can also frequently contain nutritional supplements such as vitamins, minerals and proteins, for example. Examples of specific nutritional supplements include thiamin, riboflavin, niacin, iron, calcium, or mixtures thereof.

Dough can also include flavorings such as sweeteners, spices, and specific flavorings such as bread or butter flavoring. Sweeteners include regular and high fructose corn syrup, sucrose (cane or beet sugar), and dextrose, for example. In addition to flavoring the baked good, sweeteners such as sugar can increase the moisture retention of a baked good, thereby increasing its tenderness.

Dough can also include preservatives and mold inhibitors such as sodium salts of propionic or sorbic acids, sodium diacetate, vinegar, monocalcium phosphate, lactic acid and mixtures thereof.

Methods of forming the roll-style dough product of the invention include the steps of combining ingredients for a dough in a mixing system, configured so that the atmosphere can be, if desired, controlled, optionally controlling the atmosphere in the mixing system, and mixing the ingredients to form a resulting dough.

Methods of the invention can be used with any known method of mixing doughs including but not limited to a straight dough method, and a sponge and dough method. Details of a method of the invention can therefore depend in part on the type of dough that is being mixed, and the method of mixing that is generally used with that type of dough. For example, some chemically leavened doughs require a two step process. Methods of the invention can be utilized with two step processes, as well as other types of processes. Methods of the invention can also incorporate varied mixing times. The time a dough is mixed using a method of the invention can depend in part on the type of dough that is being mixed and the general process that is being used.

Generally, the step of combining the ingredients in the mixing system depends on the particular ingredients, the type of dough being mixed, the type of process being used, and the type of mixing system being used. One of skill in the art, having read this specification, would know based on the ingredients being used, the type of process being used, and the type of mixing system being used, and how to accomplish this step.

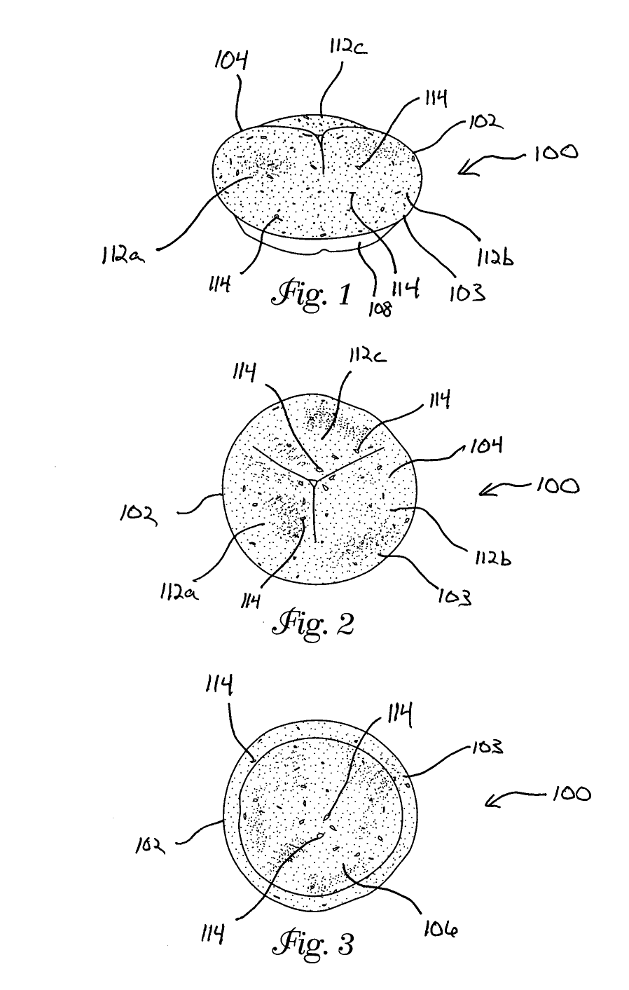

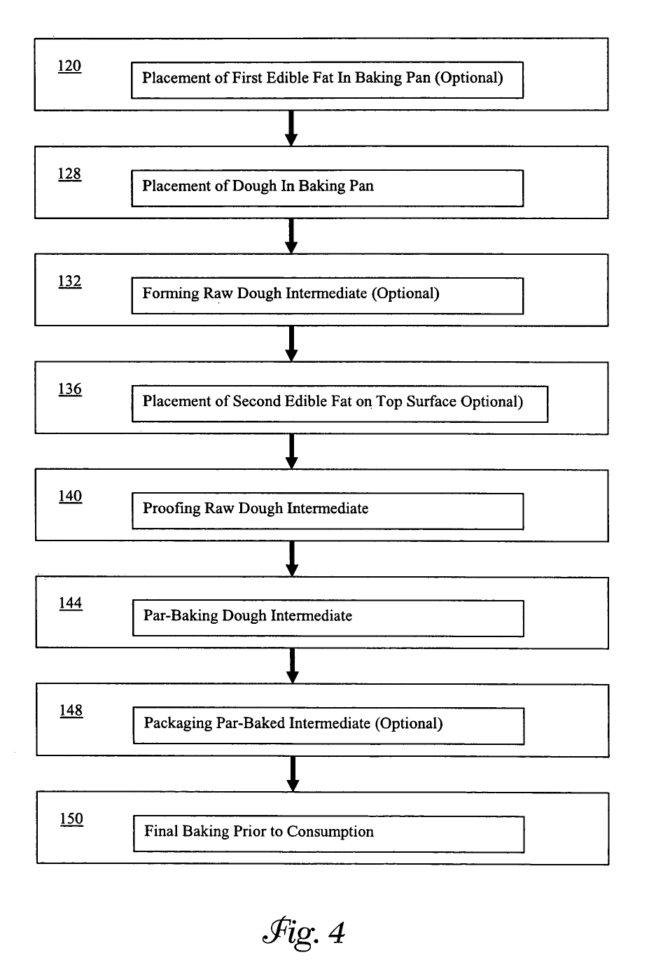

Depicted in FIGS. 1, 2 and 3 is a baked roll 100 according to an embodiment of the invention. Baked roll 100 is depicted in a roll or muffin-style configuration 102, although other suitable shapes and sizes are contemplated. Baker roll 100 comprises an exterior crust 103 defined by a top surface 104, a bottom surface 106 and a perimeter surface 108. In one example embodiment, perimeter surface 108 has a generally round perimeter though other shapes are contemplated as well. Top surface 104 can comprise a plurality sections or individual lobes, for example sections 112a, 112b, 112c. Sections 112a, 112b, 112c can provide aesthetic enhancements to baked roll 100 as well as functional enhancements for example, allowing baked roll 100 to be easily hand-separable into the individual sections 112a, 112b, 112c. Once separated, sections 112a, 112b, 112c can be individually consumed or dipped into foods such as soups, sauces or gravies and then consumed. Baked roll 100 will generally have a total weight from about 0.5 ounces to about 2.0 ounces, although larger roll sizes are contemplated.

Baked roll 100 is generally comprised of a grain based, bread-style dough of the type previously described. The grain based, bread-style dough can be prepared from the following set of ingredients: enriched flour, water, sugar, partially hydrogenated vegetable oil, yeast, butter oil, salt, whey, dough conditioners such as D.A.T.E.M, calcium sulfate, enzymes, and wheat starch. Various grains and wheat varieties can be used to impart desirable characteristics such as taste and color to baked roll 100. Grains used to make the bread-style dough can be refined grains or whole grains.

Baked roll 100 further comprises an edible cooking fat comprising from about 5% to about 20% by weight of baked roll 100. The edible cooking fat can comprise one or more solid fats or liquid oils. The edible cooking fat can comprise solid fats or liquid oils from sources including marine sources, animal sources, dairy sources, vegetable sources, fruit sources, nut sources and the like.

Generally, the edible cooking fat is presented on bottom surface 106 such that during baking, the bottom surface develops a crisp, “fried-like” texture. The edible cooking fat can also be applied to top surface 104 to develop a fried-like texture on the crust 103. The fried-like texture of baked roll 100 provides a consumer with an immediate, satisfying mouth-feel. The immediate flavor impact is generated by an immediate grease release, associated with the edible cooking fat through the consumer's olfactory and taste senses. In addition to providing baked roll 100 with the crisp, fried-like texture, the edible cooking fat can be used as a carrier to supply flavorant 114 to the crust 103 such that a consumer experiences an alternative flavor impact, associated with flavorant 114, upon biting into the crust 103.

Suitable examples of flavorant 114 can include a wide variety of flavorings such as dairy flavors, fruit flavors, nut based flavors, spices, seasonings, herbs, vegetables, cocoa-based flavors, vanilla, salt, sweet flavors and sweeteners. Suitable dairy flavors can include butter, cream, sour cream, custard, buttermilk and a variety of cheeses including cream cheese, parmesan, romano, asiago, cheddar, mozeralla, Swiss and the like. Suitable fruit flavors can include raspberry, blueberry, blackberry, strawberry, apple, pineapple, peach, cherry, citrus, coconut and the like. Suitable nut-based flavors can include walnut, pecan, almond, peanut, macadamia nut and the like. Suitable spices can include cinnamon, nutmeg, clove and the like. Suitable herbs can include basil, oregano, thyme, rosemary and Italian blend. Suitable vegetables can include onion, garlic, peppers, tomato and the like. Suitable sweet flavors and sweeteners can include honey, caramel, maple, butterscotch, molasses, sugar, brown sugar, corn syrup, sugar-replacement sweeteners and the like. When flavorant 114 is included with the edible cooking fat, an intense flavor experience is immediately delivered to the consumer in combination with the satisfying mouth-feel qualities provided by the crisp, fried-like texture. In one representative embodiment, baked roll 100 can, through the selection of an appropriate dough, edible cooking fat and flavorant 114, replicate the butter-soaked taste and crisp textural qualities of Texas Toast.

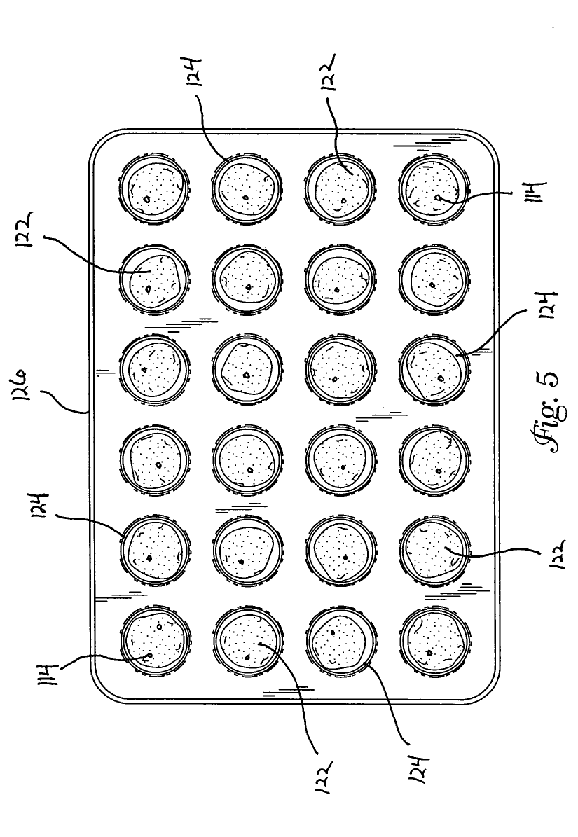

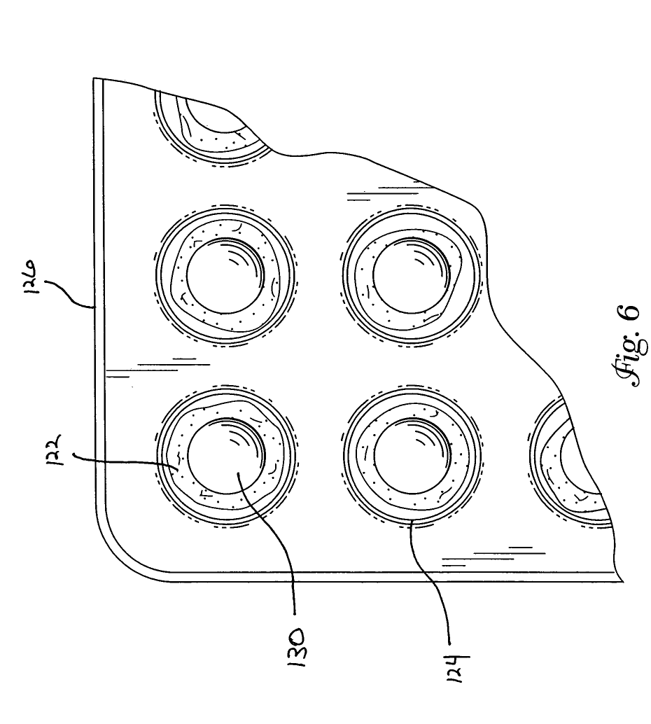

Illustrated in FIG. 4 is a flow diagram depicting representing a process for preparing a Texas Toast version of baked roll 100 of the invention. The process depicted in FIG. 4 can comprise an optional fat placement process 120, wherein a first edible fat 122 is placed in a walled recess 124 on a baking pan 126 as shown in FIG. 5. Walled recess 124 can comprise a flat bottom, round perimeter cavity as shown in FIG. 5 or may comprise other suitable shapes and configurations based upon the desired final appearance of baked roll 100. As depicted in FIG. 5, first edible fat 122 comprises an oil or fat, either solid or liquid, including those previously described. First edible fat 122 includes flavorant 114, shown in FIG. 5 as garlic. First edible fat 122 can comprise a solid fat, a liquid oil or combinations thereof. First edible fat 122 can further include an emulsified fat wherein flavorant 114 is solubilized in a small amount of water.

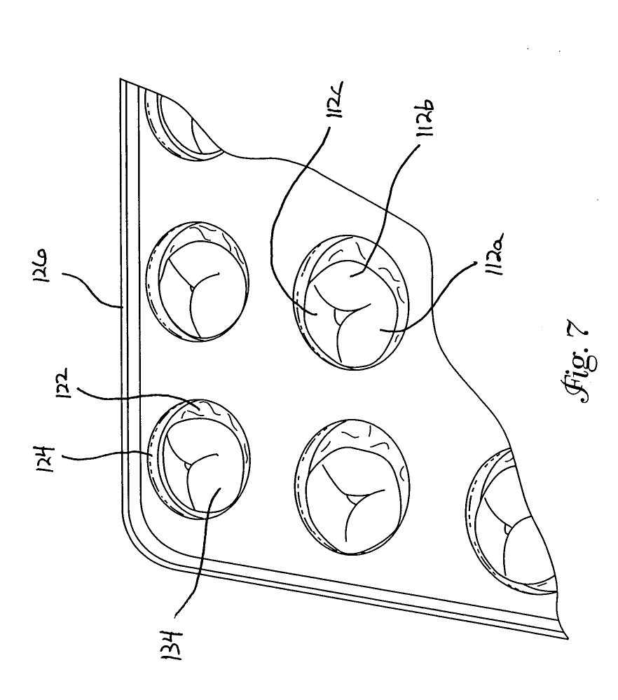

The process depicted in FIG. 4 can further comprise a dough placement process 128 wherein a portioned amount of dough 130 is placed into walled recess 124 as shown in FIG. 6. Dough 130 comprises suitable baking dough of the type and compositions previously described. Portioned amount of dough 130 preferably weighs from about 0.5 ounces to about 2.0 ounces. When the weights of the first edible fat 122 and the dough 130 are combined, the first edible fat 122 comprises from about 5% to about 20% by weight of the combination.

The process depicted in FIG. 4 can comprise an optional forming process 132 wherein dough 130 is formed within walled recess 124 to form a raw dough intermediate 134 as shown in FIG. 7. Forming process 132 can utilize a roll forming apparatus, for example as disclosed in U.S. Provisional Patent Application No. 60/549,044, which is hereby incorporated by reference to the extent not inconsistent with the present disclosure. Forming process 132 results in raw dough intermediate 134 beginning to conform to the shape of walled recess 124. Forming process 132 causes the first edible fat 122 to spread out between the raw dough intermediate 134 and the walled recess 124. During forming of raw dough intermediate 134, sections 112a, 112b, 112c can be formed into a top surface of raw dough intermediate 134.

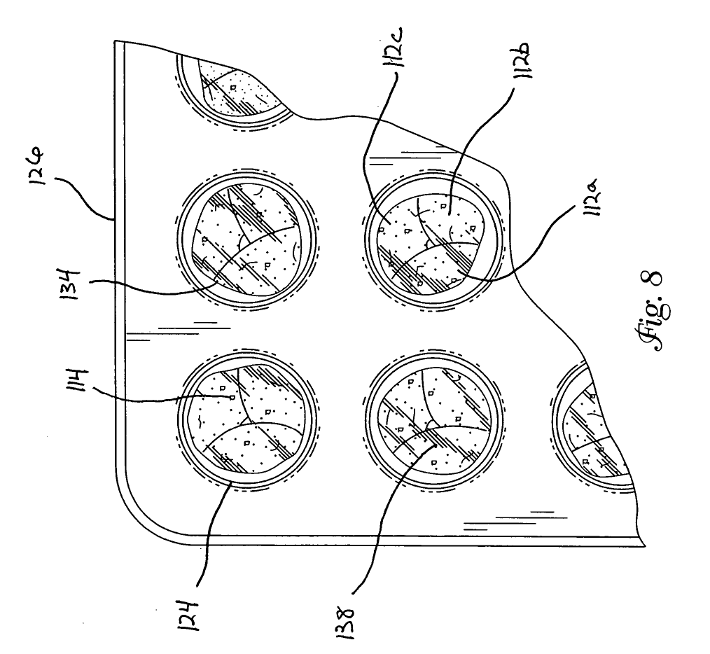

The process depicted in FIG. 4 can further comprise an optional ingredient placement process 136 wherein an ingredient such as a second edible fat 138 or flavorant 114 can be applied on the top surface of raw dough intermediate 134 as shown in FIG. 8. Second edible cooking fat 138 can be selected from the same types of edible fats from which first edible fat 122 is selected. In some embodiments, first edible fat 122 and second edible fat 138 can comprise the same edible fat. In ingredient placement process 136, second edible cooking fat 138 can be used as a carrier for applying flavorants 114 onto the top surface of raw dough intermediate 134. Alternatively, flavorant 114 can be separately added directly to the top surface of raw dough intermediate 134. Flavorants 114 can be the same or different for fat placement process 120 and ingredient placement process 136. Second edible cooking fat 138 and any flavorants 114 can be applied to the top surface by suitable application methods including, for example, spraying, shaking, spreading or the like. If optional fat placement process 120 has been omitted, ingredient placement process 136 can comprise a top application of all of the fat, herein second edible cooking fat 138, such that second edible cooking fat 138 comprises from about 5% to about 20% by weight of the combination of the dough 130 and second edible cooking fat 138.

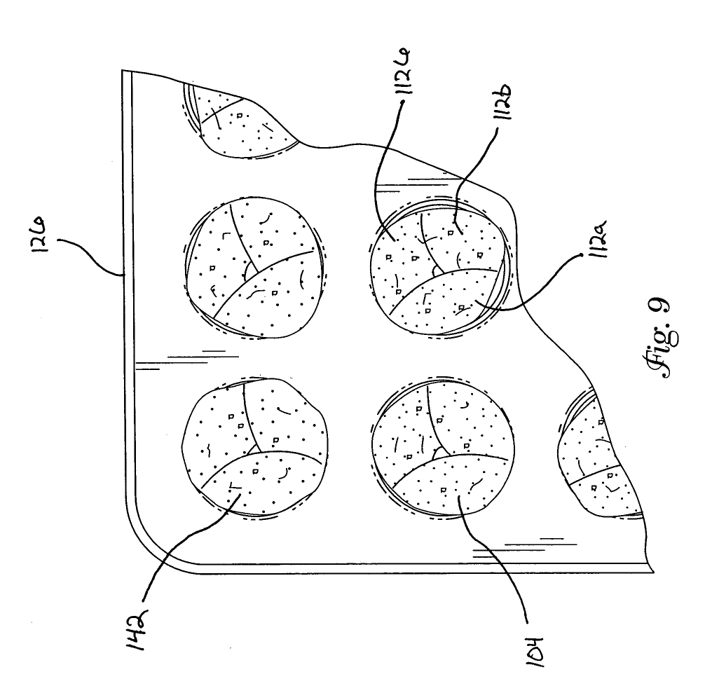

Next, the process of FIG. 4 can include a proofing process 140 wherein raw dough intermediate 134 is allowed to proof within walled recess 124 such that a proofed dough intermediate 142 expands to fill walled recess 124 as shown in FIG. 9. In some embodiments, proofed dough intermediate 142 expands such that the top surface 104 expands outside and above the top of walled recess 124.

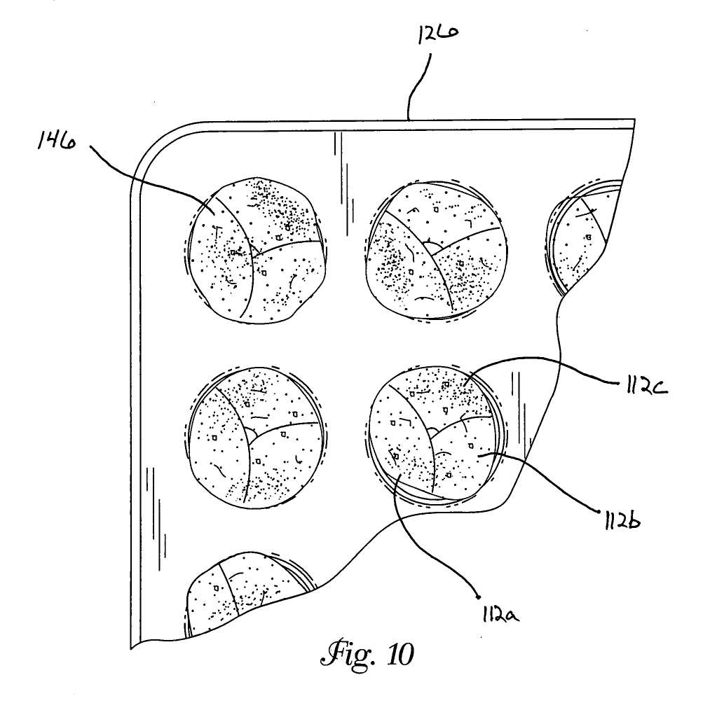

The process of FIG. 4 can further comprise a par-baking process 144 wherein proofed dough intermediate 142 is partially baked to form a par-baked dough intermediate 146 as shown in FIG. 10. Par-baked dough intermediate 146 is not fully baked and requires an additional thermal processing step prior to consumption by a consumer. Par-baked dough intermediate 142 has a crisp, fried-like texture resulting from the bottom surface being in contact with first edible fat 122 during par-baking process 144. If second edible fat 138 was previously applied to the top surface as optionally described in ingredient placement process 136, the top surface of par-baked dough intermediate 146 would also comprise a crisp, fried-like texture on the crust 103. In addition, the crust 103 of par-baked dough intermediate 146 includes any flavorants 114 carried by either first edible fat 122 or second edible fat 138 or separately applied.

The process of FIG. 4 can further comprise an optional packaging process 148 wherein par-baked dough intermediate 146 can be packaged for storage and transportation to a point of consumption. Packaging process 148 can include operations such as refrigeration and freezing. The point of consumption can include commercial locations such as bakeries, restaurants or cafeterias or may comprise residential locations. Packaging process 148 can be used to create a baking kit, for example, a kit comprising baking pan 126 and par-baked dough intermediate 146.

The process of FIG. 4 can further comprise a final baking process 150 wherein par-baked dough intermediate 146 is subjected to a second thermal or baking operation such that baked roll 100 is fully baked and ready for consumption. Baked roll 100 comprises a fried-like texture on at least bottom surface 106 and can further comprise a fried-like texture on top surface 104. Baked roll 100 further includes any flavorants 114 carried by first edible fat 122 and/or second edible fat 138. While crust 103 has the crisp, fried-like texture, an interior portion of baked roll 100 has a generally soft crumb interior as first edible fat 122 and/or second edible fat 138 remain generally on the crust 103 of baked roll 100. Prior to consumption, baked roll 100 can be hand-separated into individual sections 112a, 112b, 112c.

While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

What is claimed:

1. A baked roll comprising:
a portioned amount of dough having a bottom surface, a top surface and a perimeter surface, wherein at least the bottom surface is cooked in an amount of a first edible fat to form a fried-like texture on the bottom surface of said roll, and wherein the first edible fat is at least about 5% by weight of the roll.

2. The baked roll of claim 1, wherein the top surface comprises a second edible fat such that the top surface has a fried-like texture.

3. The baked roll of claim 2, wherein the first edible fat and the second edible fat comprise the same edible fat.

4. The baked roll of claim 1, wherein the first edible fat includes a flavorant.

5. The baked roll of claim 4, wherein the flavorant is selected from a group consisting of: a dairy flavor, a fruit flavor, a nut based flavor, a spice, a seasoning, an herb, a vegetable flavor, a cocoa-based flavor, a vanilla flavor, salt, a sweet flavor, a sweetener and combinations thereof.

6. The baked roll of claim 4, wherein the first edible fat and the flavorant deliver an intense flavor immediately upon consumption of at least a portion of the roll.

7. The baked roll of claim 1, wherein the roll has a baked weight from about 0.5 ounces to about 2.0 ounces.

8. The baked roll of claim 1, wherein the perimeter surface defines a generally round perimeter surface.

9. The baked roll claim 1, wherein the roll further comprises a plurality of lobes formed in the top surface, the lobes being easily hand-separable to provide a plurality of individual pieces.

10. A process for making a roll comprising:
placing a first edible fat in a walled recess of a baking pan;
placing a portioned amount of uncooked dough in the walled recess wherein the first edible fat comprises from about 5% by weight to about 20% by weight of a combined weight of the first edible fat and the uncooked dough;
urging the uncooked dough towards the recess walls to spread fat between said walls and said uncooked dough;
proofing the uncooked dough; and
cooking the uncooked dough to create a fried-like texture on at least a bottom surface of the roll.

11. The process of claim 10, wherein proofing the uncooked dough causes a top surface of the uncooked dough to rise out of the walled recess.

12. The process of claim 10, wherein the roll is partially baked.

13. The process of claim 10, further comprising at least one additional processing step selected from freezing the roll, refrigerating the roll or packaging the roll.

14. The process of claim 10, wherein contacting the dough with a forming member forms a plurality of sections which form individually separable portions.

15. The process of claim 10, further comprising adding a flavorant to the first edible fat such that the flavorant is baked onto the bottom surface of the roll.

16. The process of claim 10, further comprising applying a second edible fat on a top surface of the uncooked dough, which upon baking forms a fried-like top surface.

17. A ready-for-baking kit comprising:
a pan comprising a plurality of walled recesses;
a first edible fat present in the bottom of each walled recess; and
a portioned amount of dough in each of said plurality of walled recesses, the dough defining a top surface, a bottom surface and a perimeter surface,
wherein the dough, upon baking, has a fried-like texture on at least the bottom surface; and
wherein the first edible fat comprises at least about 5% by weight of the combined weight of the first edible fat and the proofed dough.

18. The ready-for-baking kit of claim 17, wherein the first edible fat comprises a flavorant.

19. The ready-for-baking kit of claim 17, wherein the dough further comprises a second edible fat applied to the top surface of the dough.

20. The ready-for-baking kit of claim 17, wherein the dough comprises a plurality of dough sections.

21. A dough intermediate comprising an amount of proofed dough having a bottom surface, a top surface and a perimeter surface, the bottom surface comprising a layer of a first edible fat wherein the first edible fat comprises at least about 5% by weight of the proofed dough product.

22. The dough intermediate of claim 21, wherein the cooking fat comprises a flavorant.

23. The dough intermediate of claim 21, wherein the top surface comprise an amount of a second edible fat.

24. The dough intermediate of claim 23, wherein the first edible fat and the second edible fat comprise the same edible fat.

25. A Texas Toast flavored roll comprising:
a portioned amount of baked dough and at least one edible fat, the edible fat comprising from about 5% to about 20% by weight of the flavored roll;
wherein the baked dough has a fried like crust; and
wherein the at least one edible fat comprises a garlic flavorant such that the garlic flavorant is presented on the fried like crust to deliver an immediate flavor impact at consumption.

26. The Texas Toast flavored roll of claim 25, wherein the portioned amount of baked dough comprises a section designation formed in the exterior crust such that the flavored roll is hand-separable into a plurality of individual roll sections.
